(19) United States
(12) Patent Application Publication
(10) Pub. No.: US 2026/0097502 A1
(43) Pub. Date: Apr. 9, 2026

(54) INTEGRATED OPERATION SYSTEM FOR HETEROGENEOUS LOGISTICS ROBOTS AND METHOD THEREFOR

(71) Applicants: Hyundai Motor Company, Seoul (KR); Kia Corporation, Seoul (KR)

(72) Inventors: Kyung Dong PARK, Gyeonggi-do (KR); Kyeun AHN, Gyeonggi-do (KR)

(21) Appl. No.: 19/113,313

(22) PCT Filed: Jun. 15, 2023
(86) PCT No.: PCT/KR2023/008284

§ 371 Date: Mar. 19, 2025

(30) Foreign Application Priority Data
Sep. 20, 2022 (KR) 10-2022-0118644

(51) Int. Cl. B25J 9/16; G06Q 10/08

(52) U.S. Cl. CPC B25J 9/1666; B25J 9/161; G06Q 10/08

(57) ABSTRACT

A heterogeneous logistics robot integrated operation system and a method thereof are disclosed. According to an embodiment of the present invention, the heterogeneous logistics robot integrated operation system comprises: a first logistics robot configured to transport logistics in a production plant and a second logistics robot configured to be a different model from the first logistics robot; a first local control system configured to control an operational state of the first logistics robot and a second local control system configured to control an operational state of the second logistics robot; an integrated control system configured to collect location information of the first logistics robot and the second logistics robot and monitor whether the first logistics robot and the second logistics robot are simultaneously located within a preset traffic area based on the location information; wherein, when the first logistics robot and the second logistics robot are simultaneously located within the traffic area, at least one of the integrated control system and the local control system is configured to perform traffic control by stopping or decelerating the logistics robots and then sequentially operating according to a predetermined priority condition.

### TECHNICAL FIELD

The present invention relates to a heterogeneous logistics robot integrated operation system and a method thereof, more specifically, relates to a heterogeneous logistics robot integrated operation system and a method thereof that support optimal (smooth) route operation by controlling the traffic of heterogeneous AGVs/AMRs utilized in industrial sites.

### BACKGROUND ART

In general, vehicle manufacturing plants based on Smart Factory systems modularize automated line processes to assemble various parts of different components, and to ensure flexible transportation of parts (including products and others) for each process, heterogeneous logistics robots are operated. In automated processes, any disruption in the supply of parts during operation can cause line stoppages and impact productivity. Therefore, ensuring the timely and accurate supply of parts through the smooth operation of logistics robots is crucial.

Meanwhile, heterogeneous logistics robots, including Automated Guided Vehicles (AGVs) and Autonomous Mobile Robots (AMRs) from different manufacturers, are deployed for operations and are managed through separate local systems depending on the manufacturer and model.

However, when AGVs and AMRs are operated simultaneously within the limited space of a factory, traffic zones inevitably occur due to overlapping transportation routes, and, in these traffic zones, AGVs and AMRs of different manufacturers (models) or purposes are unable to communicate with each other, making traffic control impossible.

Additionally, the absence of an interconnection means between different systems operating heterogeneous logistics robots separately can cause collision accidents in sections where different routes overlap, such as intersections, and delays in parts supply due to increased traffic.

Additionally, increasing the number of logistics robots to ensure smooth parts supply has the drawback of higher costs, and in a limited space, the increased congestion (density) of logistics robots can further exacerbate traffic problems.

Therefore, a solution is required to improve the operational efficiency (turnover rate) of logistics robots through traffic control and efficient operation of heterogeneous logistics robots.

The matters described in this background technology section are provided to enhance the understanding of the background of the invention and may include aspects that are not part of the prior art already known to those of ordinary skill in the field.

### DISCLOSURE

### Technical Problem

An embodiment of the present invention aims to provide a heterogeneous logistics robot integrated operation system and a method thereof, which centrally integrate and control heterogeneous logistics robots from different manufacturers operated in a production plant, identify logistics robots present in traffic areas or overlapping routes, and perform traffic control by sequentially dispatching the logistics robots according to a priority condition.

Another objective of the present invention is to provide a heterogeneous logistics robot integrated operation system and a method thereof, which enhance the operational efficiency of logistics robots by centrally monitoring the operational states of different heterogeneous logistics robots and controlling them through detour routes when an event occurs on a transportation route.

### Technical Solution

According to an exemplary embodiment, there is provided a heterogeneous logistics robot integrated operation system including: a first logistics robot configured to transport logistics in a production plant and a second logistics robot configured to be a different model from the first logistics robot; a first local control system configured to control an operational state of the first logistics robot and a second local control system configured to control an operational state of the second logistics robot; an integrated control system configured to collect location information of the first logistics robot and the second logistics robot and monitor whether the first logistics robot and the second logistics robot are simultaneously located within a preset traffic area based on the location information; wherein, when the first logistics robot and the second logistics robot are simultaneously located within the traffic area, at least one of the integrated control system and the local control system is configured to perform traffic control by stopping or decelerating the logistics robots and then sequentially operating according to a predetermined priority condition.

The integrated control system may be configured to perform traffic control by tracking transportation routes of the logistics robots, identifying and stopping a plurality of logistics robots present in an overlapping route, and sequentially dispatching the plurality of logistics robots according to a predetermined priority condition.

The local control system may be configured to identify location information of heterogeneous logistics robots including an Automated Guided Vehicle (AGV) and an Autonomous Mobile Robot (AMR) and transmit the location information to the integrated control system.

The location information may include a logistics robot ID, a current coordinate in a factory map (MAP) coordinate system, a movement direction and a speed.

The integrated control system may include: a task management unit configured to select at least one logistics robot required for transportation based on logistics sequence information according to the type of logistics and to determine a departure point and a destination; a traffic area setting unit configured to set a traffic area for priority-based traffic control at intersections where transportation routes of the logistics robots overlap; a monitoring unit configured to collect location information of the logistics robots through the local control system and monitor traffic occurrence conditions; a database (DB) configured to store at least one program and data for the integrated operation of the heterogeneous logistics robots; and a control unit configured to check current location information of logistics robots that have entered the traffic area and control the logistics robots to decelerate or temporarily stop according to the section corresponding to the traffic area through the local control system.

The traffic area setting unit may be configured to provide a factory design drawing (CAD) through a traffic control setting screen and set a traffic area in a section where traffic occurs by utilizing various shapes.

The traffic area may be set in a section designated (Draw) by a user or be automatically set by detecting traffic coordinates where a plurality of routes overlap on the design drawing.

The traffic area may include an alert section, a warning section, and a standby section, each having a different shape size based on the level of risk centered on the traffic coordinates, and may be configured to perform deceleration or stop control according to the section corresponding to the location information of the logistics robot.

The traffic area setting unit may be configured to set a priority condition for the traffic control through a traffic control setting screen, the priority condition being used to sequentially dispatch logistics robots that have stopped after entering the traffic area or an overlapping route.

The priority condition may include at least one of: an order in which logistics robots have lower remaining battery levels, an order in which logistics robots have shorter remaining distances to the destination, an order in which logistics robots have higher process priority, an order in which logistics robots have longer remaining distances to the destination, an order in which logistics robots have higher supply priority, an order in which logistics robots have higher retrieval priority, an order in which priority is higher between different models (AGV/AMR), and an order in which priority is higher between process cells (Cell).

The priority condition may have a relative priority weight value applied to each item, and the weight value may be variably adjusted according to the work schedule in the production plant and the operational status of the logistics robots.

The control unit may be configured to track the location of the logistics robot through the monitoring unit, detect entry into the traffic area, and transmit a deceleration or stop command through the local control system corresponding to the model of the logistics robot.

The control unit may be configured to determine the priority of a plurality of logistics robots present in the traffic area based on the priority condition and control the sequential dispatch or movement of the plurality of logistics robots.

The control unit may be configured to generate a virtual robot area at a predetermined distance from the perimeter of the logistics robot through the monitoring unit to ensure a safety distance and control the logistics robot to stop when the virtual robot areas overlap with each other.

The control unit may be configured to regenerate and transmit a detour route through the integrated route setting unit based on monitoring when at least one of an obstacle situation in front of the logistics robot, a congestion situation, or lane-specific congestion is detected.

According to an exemplary embodiment, there is provided a method for integrated operation of heterogeneous logistics robots, wherein an integrated control system may operate heterogeneous logistics robots of different models, the method including: setting a traffic area in a section where transportation routes overlap in a production plant and setting a priority condition for traffic control of logistics robots that have entered the traffic area; determining a departure point and a destination of a first logistics robot for logistics transportation and generating task assignment information including a transportation route through a first local control system to operate the first logistics robot; collecting location information of the first logistics robot from the first local control system and monitoring an operational state of the first logistics robot; and performing traffic control by stopping or decelerating the first logistics robot when monitoring detects that the first logistics robot has entered the traffic area where at least one second logistics robot is present or when an overlapping route with the second logistics robot occurs, and then sequentially operating according to a predetermined priority condition.

The performing of the traffic control may include: determining a higher-priority logistics robot and a lower-priority logistics robot based on a priority condition that includes at least one of an order in which logistics robots have lower remaining battery levels, an order in which logistics robots have shorter remaining distances to the destination, an order in which logistics robots have higher process priority, an order in which logistics robots have longer remaining distances to the destination, an order in which logistics robots have higher supply priority, an order in which logistics robots have higher retrieval priority, an order in which priority is higher between different models (AGV/AMR), and an order in which priority is higher between process cells (Cell); and dispatching the higher-priority logistics robot first and keeping the lower-priority logistics robot on standby.

The performing of the traffic control may include: decelerating and stopping the first logistics robot and the second logistics robot through the first local control system and the second local control system when an overlapping route with the second logistics robot occurs; and dispatching either the first logistics robot or the second logistics robot first based on the priority condition while keeping the lower-priority logistics robot on standby.

The performing of the traffic control may further include: detecting, through monitoring, an occurrence of an obstacle or congestion event on the transportation route of the first logistics robot; and regenerating a detour route through a task management unit or the first local control system and transmitting the detour route to the first logistics robot.

The regenerating of the detour route may include at least one of: canceling an existing transportation route that uses a first lane (Lane#1) where the event has occurred and regenerating a detour route using a second lane (Lane#2); and comparing the occupancy rates of the first lane (Lane#1) in the existing transportation route and the second lane (Lane#2) in the detour route and resetting the route to utilize the second lane (Lane#2) with a lower occupancy rate.

### Advantageous Effects

According to an embodiment of the present invention, by integrating and operating heterogeneous logistics robots of different manufacturers or models through an integrated control system implemented in a production plant, traffic control can be achieved between logistics robots that cannot communicate with each other without requiring additional components.

Additionally, by monitoring the operational state of each heterogeneous logistics robot through a heterogeneous local control system and identifying logistics robots entering fixed traffic areas, such as intersections, or overlapping routes, priority-based traffic control can be performed, ensuring a smooth supply of logistics.

Furthermore, by detecting obstacle events or congestion situations on transportation routes of logistics robots in real time and controlling the logistics robots to quickly move along detour routes to avoid such situations, the turnover rate of logistics robots can be maximized, thereby reducing additional deployment costs and achieving maximum operational efficiency with a minimal number of logistics robots.

### DESCRIPTION OF THE DRAWINGS

FIG. 1 schematically illustrates the configuration of a heterogeneous logistics robot integrated operation system according to an embodiment of the present invention.

FIG. 2 illustrates a heterogeneous logistics robot integrated operation system implemented in a vehicle manufacturing plant according to an embodiment of the present invention.

FIG. 3 illustrates a priority-based route traffic control setting screen according to an embodiment of the present invention.

FIG. 4 illustrates a state in which heterogeneous logistics robots have entered a traffic area according to an embodiment of the present invention.

FIG. 5 illustrates a state in which overlapping routes between multiple logistics robots are detected according to an embodiment of the present invention.

FIG. 6 is a flowchart schematically illustrating a heterogeneous logistics robot integrated operation method according to an embodiment of the present invention.

FIG. 7 illustrates an example of traffic control between logistics robots in a traffic area according to an embodiment of the present invention.

FIGS. 8 and 9 illustrate examples of traffic control for logistics robots in response to a front obstacle event according to an embodiment of the present invention.

### MODE FOR INVENTION

The embodiments of the present invention will now be described in detail with reference to the accompanying drawings to enable those skilled in the art to which the present invention pertains to readily implement the invention.

The terminology used herein is solely for the purpose of describing specific embodiments and is not intended to limit the present invention. As used herein, singular forms are intended to include plural forms as well, unless explicitly stated otherwise in the context. The terms “include” and/or “including,” as used in this specification, specify the presence of stated features, elements, steps, operations, components, and/or modules, but do not preclude the presence or addition of one or more other features, elements, steps, operations, components, modules, and/or groups thereof. As used herein, the term “and/or” includes any and all combinations of the associated listed items.

Throughout this specification, terms such as first, second, A, B, (a), and (b) may be used to describe various components, but these components should not be limited by these terms. Such terms are used solely to distinguish one component from another and do not define the nature, order, or sequence of the corresponding components.

Throughout this specification, when a component is described as being “connected to” or “coupled to” another component, it should be understood that the component may be directly connected or coupled to the other component, or an intermediate component may be present between them. In contrast, when a component is described as being “directly connected to” or “directly coupled to” another component, it should be understood that there are no intermediate components between them.

Additionally, it is understood that one or more of the methods described below, or aspects thereof, may be executed by at least one control unit. The term “control unit” may refer to a hardware device that includes memory and a processor. The memory is configured to store program instructions, and the processor is specifically programmed to execute the program instructions to perform one or more processes described below. The control unit may control the operation of units, modules, components, devices, or similar elements as described herein. Furthermore, it is understood that the methods described below may be executed by a device that includes the control unit along with one or more other components, as recognized by those skilled in the art.

Moreover, the control unit of the present disclosure may be implemented as a non-transitory computer-readable recording medium containing executable program instructions executed by a processor. Examples of computer-readable recording media include Read-Only Memory (ROM), Random-Access Memory (RAM), Compact Disc (CD)-ROMs, magnetic tapes, floppy disks, flash drives, smart cards, and optical data storage devices, but are not limited thereto.

The heterogeneous logistics robot integrated operation system and method according to an embodiment of the present invention will now be described in detail with reference to the drawings.

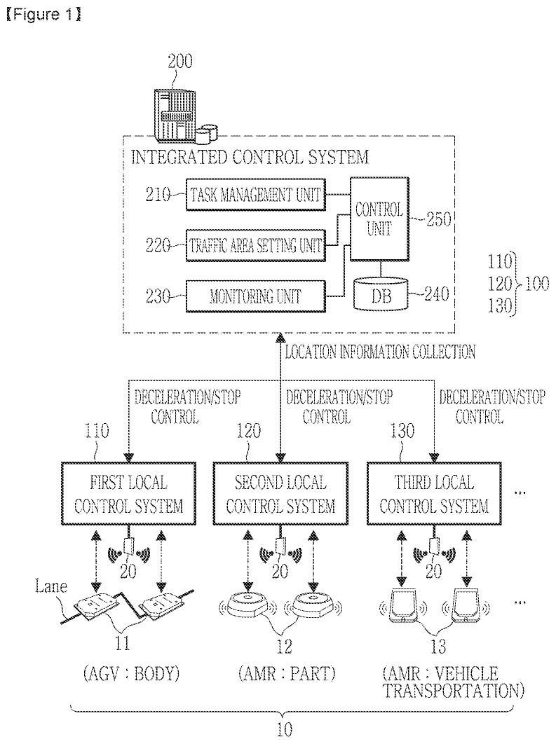

FIG. 1 schematically illustrates the configuration of a heterogeneous logistics robot integrated operation system according to an embodiment of the present invention.

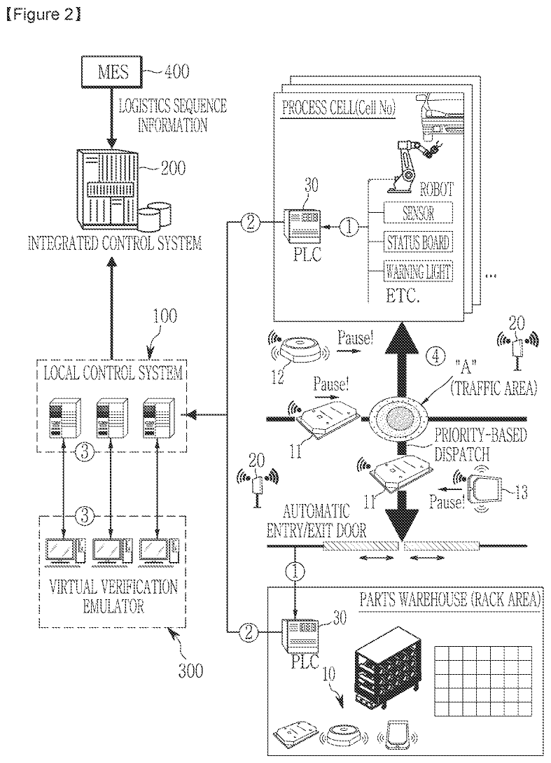

FIG. 2 illustrates a heterogeneous logistics robot integrated operation system implemented in a vehicle manufacturing plant according to an embodiment of the present invention.

Referring to FIGS. 1 and 2, the heterogeneous logistics robot integrated operation system according to an embodiment of the present invention includes heterogeneous logistics robots 10 that transport logistics in a production plant and have different models, a heterogeneous local control system 100 configured to control the operational states of the heterogeneous logistics robots 10, and an integrated control system 200 configured to collect location information of the heterogeneous logistics robots 10 and monitor whether the heterogeneous logistics robots 10 are simultaneously located within a preset traffic area A based on the location information. When the heterogeneous logistics robots 10 are simultaneously located within the traffic area A, at least one of the integrated control system 200 and the local control system 100 is configured to perform traffic control by stopping or decelerating the logistics robots and then sequentially operating them according to a predetermined priority condition.

For example, the integrated control system 200 tracks the transportation routes of the logistics robots 10 based on the location information collected through the local control system 100 and/or the logistics robots 10. It then identifies multiple logistics robots 10 present in overlapping routes, stops them, and performs traffic control to sequentially dispatch them according to the predetermined priority condition.

Hereinafter, the heterogeneous logistics robot integrated operation system according to an embodiment of the present invention will be described based on the assumption that heterogeneous logistics robots 10 are integrated and operated in a smart factory-based automobile manufacturing plant.

As shown in FIG. 2, the heterogeneous logistics robot integrated operation system applied to a vehicle manufacturing plant according to an embodiment of the present invention is implemented through the following processes: \textcircled{1} installing sensors and connecting a PLC 30, \textcircled{2} establishing communication and checking data, \textcircled{3} performing virtual verification using an emulator 300, and \textcircled{4} addressing issues based on production operations.

The process \textcircled{1} involves installing sensors for detecting the status of automated line processes and parts warehouses, as well as equipment such as status boards and warning lights, and connecting them to a PLC 30 for operation control.

For example, the PLC 30 is installed for each line process and can control various automation facilities required for component assembly based on the work conditions set in the PLC memory. Additionally, the PLC 30 can control the operation of various automation facilities (e.g., doors, elevators, etc.) installed at transit points (nodes) that the logistics robots 10 must pass through for logistics transportation.

The process \textcircled{2} involves establishing communication between the local control system 100 and the PLCs 30 and checking the transmission and reception status of data. Additionally, the communication connection status between the local control system 100 and the heterogeneous logistics robots 10 can be checked through the relay device 20.

The process \textcircled{3} involves generating virtual PLC signals in the emulator 300, verifying the operational states of the heterogeneous logistics robots 10 based on the production work schedule, and validating the traffic control status.

The process \textcircled{4} involves checking logistics sequence information in the integrated control system 200 to address issues that arise when controlling task missions based on line process operating conditions and monitoring the operational states of the logistics robots 10 centrally to ensure safe operation.

In particular, the integrated control system 200 according to an embodiment of the present invention centrally performs priority-based traffic control when heterogeneous logistics robots 10 enter the traffic area A or when overlapping routes occur and directly controls detour (avoidance) operations by regenerating an optimal route in response to event-driven obstacles or congestion situations.

The logistics robot 10 is a means for transporting products and parts in a vehicle manufacturing plant and includes AGVs (Automated Guided Vehicles) 11 and heterogeneous AMRs (Autonomous Mobile Robots) 12 and 13 from different manufacturers, and the logistics robots may be provided in various specifications (e.g., size, shape) and operating methods depending on the work application.

For example, the AGV 11 may transport vehicle bodies or related components, while the AMRs 12 and 13 may supply parts required for the line process according to their model type or transport completed vehicles to designated parking areas.

The AGV 11 is generally guided along lanes installed on the floor, whereas the AMRs 12 and 13 autonomously navigate by detecting their surroundings through sensors, resulting in a difference in operating methods.

Additionally, AGV 11 and AMRs 12 and 13 from different manufacturers have different communication protocols, making mutual communication impossible. While AMRs 12 and 13 operate in a similar manner, they may be different models from different manufacturers.

Therefore, the local control system 100 may include a first local control system 110 configured to control the operational state of AGV 11 according to its manufacturer (or model), a second local control system 120 configured to control the operational state of AMR 12, and a third local control system 130 configured to control the operational state of AMR 13. Here, for convenience, the local control system is assumed to consist of three units; however, it is not limited thereto, and in practice, a vehicle manufacturing plant may operate dozens of local control systems and hundreds of logistics robots 10.

The local control system 100, upon receiving departure point and destination information for logistics transportation from the integrated control server 200, generates a transportation route and transmits task assignment information to the corresponding logistics robot 10. The transportation route may include at least one waypoint (transit node) that the logistics robot 10 must pass through from the departure point to the destination. Additionally, if the logistics is large in size, the transportation route may be generated to enable multiple logistics robots 10 to perform cooperative clustered driving to the destination. The heterogeneous logistics robots 10, including AGV 11 and AMRs 12 and 13, determine their current location information while moving along their respective designated routes and transmit the information to the corresponding local control systems 110, 120, and 130 through the wireless relay 20. The location information may include a logistics robot ID, a current coordinate in the factory map (MAP) coordinate system, a movement direction, and a speed, including a stationary state.

For example, when AGV 11 receives a transportation route including the departure point and the destination, it moves along the lanes installed on the floor and identifies markers displayed near the lanes during movement to determine its current location information.

Additionally, when AMRs 12 and 13 receive a transportation route including the departure point and the destination, they may determine their current location information using the SLAM (Simultaneous Localization and Mapping) method during autonomous navigation.

In addition, each local control system 110, 120, and 130 may determine the location information of the corresponding logistics robots 10 based on manufacturer-specific methods, such as recognizing tag IDs assigned to nodes or sections along the transportation route, or by using indoor positioning methods through communication devices such as the relay 20.

Each local control system 110, 120, and 130 transmits the location information obtained from the corresponding logistics robots 10 to the higher-level integrated control system 200.

The integrated control system 200 is a higher-level control system that centrally controls the operational states of the heterogeneous logistics robots 10 according to an embodiment of the present invention.

The integrated control system 200 includes a task management unit 210, a traffic area setting unit 220, a monitoring unit 230, a database (DB) 240, and a control unit 250.

The task management unit 210 assigns tasks to the logistics robots 10 to ensure timely and accurate supply of logistics by considering the production work schedule of the Manufacturing Execution System (MES) 400 and the operational status of each process line.

In this process, the task management unit 210 selects at least one logistics robot 10 required (or suitable) for transportation according to the type of logistics and determines the departure point and the destination.

The task management unit 210 may transmit task assignment information and departure point/destination information of the logistics robots 10 to the local control system 100 corresponding to the model (manufacturer). Accordingly, as described earlier, the local control system 100 may generate a transportation route based on the departure point and destination information.

However, the transportation route is not limited to this method, and the task management unit 210 of the integrated control system 200 may also directly generate the transportation route and transmit it to the corresponding logistics robot 10 through the local control system 100. For example, the task management unit 210 may designate a logistics robot 10, generate task assignment information including a transportation route created based on the departure point and destination information, and transmit it through the corresponding local control system 100. This enables compensation for transportation route generation in case of a failure in a specific local control system 100 and allows centralized control of transportation routes.

Additionally, the task management unit 210 may regenerate a detour (avoidance) route when a logistics robot 10 enters a traffic area A, when an obstacle/congestion occurs, or based on lane-specific congestion.

The traffic area setting unit 220 sets a traffic area A at intersections (branch points) where the transportation routes of logistics robots 10 overlap to enable priority-based traffic control.

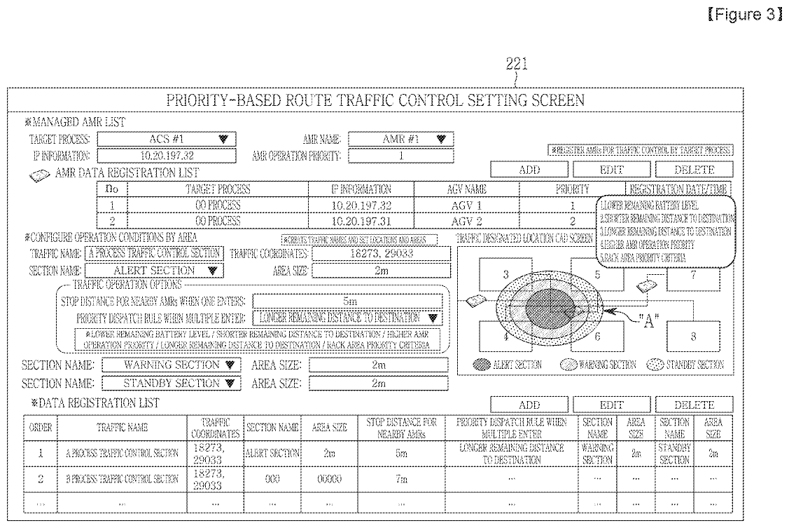

FIG. 3 illustrates a priority-based route traffic control setting screen according to an embodiment of the present invention.

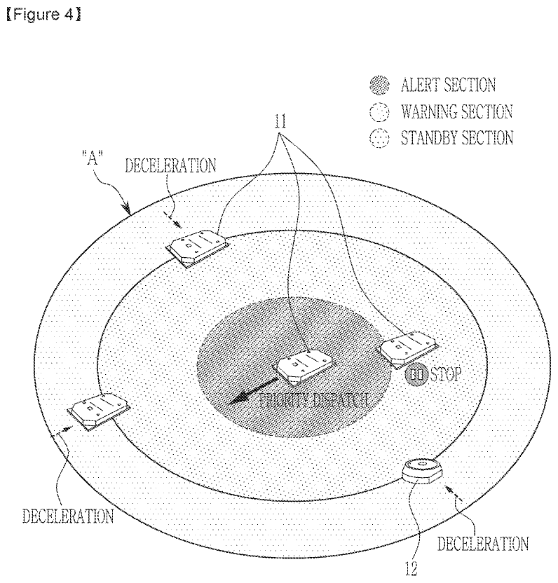

FIG. 4 illustrates a state in which heterogeneous logistics robots have entered a traffic area according to an embodiment of the present invention.

Referring to FIGS. 3 and 4, the traffic area setting unit 220 displays a factory design drawing (CAD) through a traffic control setting screen 221 and sets a traffic area A in a section where traffic occurs by utilizing various shapes such as circles, rectangles, and polygons. The traffic area A may be set in a section designated (Draw) by a user or may be automatically set by detecting traffic coordinates (e.g., intersections) where multiple routes overlap in the design drawing. The traffic area A includes an alert section, a warning section, and a standby section, each having a different shape size based on the level of risk centered on the traffic coordinates. The closer the shape size is to the traffic coordinates, the smaller it becomes, and the higher the risk level increases. Accordingly, deceleration or stop control is performed based on the section corresponding to the location information of the logistics robot 10 that has entered the traffic area A.

Additionally, the traffic area setting unit 220 may set priority conditions for traffic control through the traffic control setting screen 221 to sequentially dispatch logistics robots 10 that have stopped after entering the traffic area A or an overlapping route.

For example, the priority conditions may include at least one of the following: an order in which logistics robots 10 with lower remaining battery levels are dispatched first, an order in which logistics robots 10 with shorter remaining distances to the destination are dispatched first, an order in which logistics robots 10 with higher process priority are dispatched first, an order in which logistics robots 10 with longer remaining distances to the destination are dispatched first, an order in which logistics robots 10 with higher supply priority are dispatched first, an order in which logistics robots 10 with higher retrieval priority are dispatched first, an order in which priority is higher between different models (AGV/AMR), and an order in which priority is higher between process cells.

Here, the order based on lower remaining battery levels refers to a condition in which logistics robots 10 with relatively lower remaining battery levels are dispatched first.

Additionally, the order based on shorter remaining distances to the destination refers to a condition in which logistics robots 10 with relatively shorter remaining distances to the destination are dispatched first.

Additionally, the order based on higher process priority refers to a condition in which logistics robots 10 with relatively higher priority in the line process are dispatched first.

Additionally, the order based on longer remaining distances to the destination refers to a condition in which logistics robots 10 with relatively longer remaining distances to the destination are dispatched first.

Additionally, the order based on higher supply priority refers to a condition in which logistics robots 10 with relatively more urgent parts supply requirements for the line process are dispatched first.

Additionally, the order based on higher retrieval priority refers to a condition in which logistics robots 10 requiring more urgent parts retrieval or urgent retrieval of a specific model (AGV/AMR) for the next task assignment are dispatched first.

Additionally, the order based on higher priority between models (AGV/AMR) refers to a condition in which logistics robots 10 of relatively higher priority models are dispatched first.

Additionally, the order based on higher priority between process cells (Cell) refers to a condition in which logistics robots 10 destined for process cells of relatively higher importance are dispatched first.

These priority conditions have relative priority weight values (%) applied to each item, and the weight values may be variably adjusted according to the work schedule in the production plant and the operational status of the logistics robots 10. Accordingly, when performing traffic control for multiple logistics robots 10 based on the priority conditions, the weight of each priority item may be adjusted according to the operational state of the production plant to ensure smooth parts supply and retrieval.

The monitoring unit 230 stores the transportation routes assigned to the logistics robots 10 operating in the production plant and monitors traffic occurrences by collecting the IDs and location information of the logistics robots 10 through the manufacturer-specific local control systems 100. The monitoring unit 230 may also support communication means that accommodate different communication protocols for each manufacturer, enabling mutual integration.

The database (DB) 240 stores at least one program and data required for the integrated operation of heterogeneous logistics robots by the integrated control system 200 according to an embodiment of the present invention and stores the information collected and generated during operation.

The control unit 250 controls the overall operation of each component for the integrated operation of heterogeneous logistics robots according to an embodiment of the present invention.

For example, the control unit 250 may execute the functions of each component by referring to and executing the programs and data stored in the database 240, serving as the main control entity.

The control unit 250 tracks the location of the operating logistics robots 10 based on the location information collected through the monitoring unit 230 and detects when they enter a preset traffic area A.

The control unit 250 then checks the current location information of the logistics robots 10 that have entered the traffic area A and controls them to decelerate or temporarily stop according to the corresponding section of the traffic area. At this time, the control unit 250 may transmit the deceleration or stop command through the local control system 100 corresponding to the model of the logistics robot 10.

Subsequently, the control unit 250 may determine the priority of multiple logistics robots 10 stopped within the traffic area A based on the priority conditions and control their sequential operation (departure and movement). Through this process, traffic control for heterogeneous logistics robots that cannot communicate with each other within the production plant may be achieved.

Accordingly, the logistics robots 10 may move along the transportation routes assigned by the higher-level integrated control system 200, decelerate or stop within the traffic area A according to the commands received through the corresponding local control system 100, and then proceed based on the departure command issued according to the priority conditions.

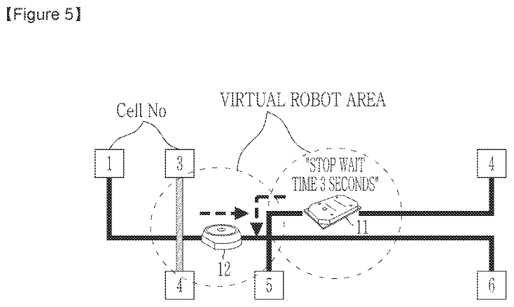

Meanwhile, FIG. 5 illustrates a state in which overlapping routes between multiple logistics robots are detected according to an embodiment of the present invention.

Referring to FIG. 5, in the transportation routes between process cells 1, 2, 3, 4, 5, and 6, the monitoring unit 230 according to an embodiment of the present invention may monitor the presence of overlapping routes where logistics robots 10 intersect based on their transportation routes and real-time location information, in addition to the traffic area A.

Here, the traffic area A is designated for traffic control in specific fixed sections where congestion frequently occurs, while the overlapping routes are monitored to predict event-driven traffic situations that may occur in unspecified sections and ensure safe control without mutual interference or collisions.

Accordingly, when the control unit 250 detects overlapping routes of logistics robots 10 through the monitoring unit 230, it may stop the corresponding logistics robots 10 and sequentially issue departure commands according to the predetermined priority conditions.

At this time, the control unit 250 may generate a virtual robot area at a predetermined distance from the logistics robots 10 through the monitoring unit 230 to ensure a safety distance and control the logistics robots 10 to stop when the virtual robot areas overlap. The control unit 250 may then dispatch the higher-priority logistics robot 10 first according to the priority conditions and control the lower-priority logistics robot 10 to remain stopped for a predetermined period (e.g., 3 seconds) before allowing it to proceed. The virtual robot area may be set as a radius of a predetermined distance (e.g., 5 meters) centered on the logistics robot 10.

Additionally, based on the monitoring results, the control unit 250 may regenerate and transmit a detour route through the task management unit 210 when at least one of an obstacle situation in front of the logistics robot 10, a congestion situation, or real-time lane congestion occurs.

The control unit 250 may be implemented as one or more processors operating under a predefined program, and the predefined program may be programmed to execute each step of the heterogeneous logistics robot integrated operation method in a production plant according to an embodiment of the present invention.

This heterogeneous logistics robot integrated operation method in a production plant will be described in more detail with reference to the following drawings.

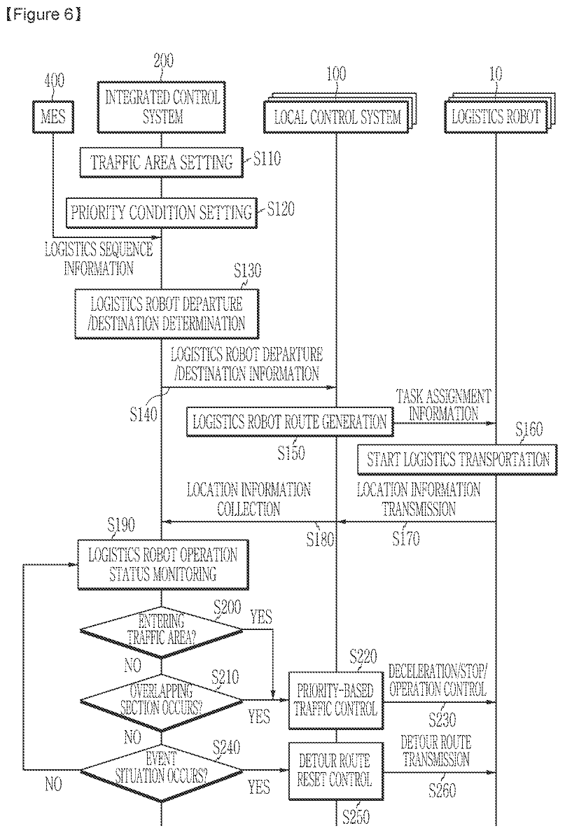

FIG. 6 is a flowchart schematically illustrating the heterogeneous logistics robot integrated operation method according to an embodiment of the present invention.

Referring to FIG. 6, the integrated control system 200 according to an embodiment of the present invention sets a traffic area A in advance at sections where routes overlap, such as intersections (S110), and establishes priority conditions for traffic control of heterogeneous logistics robots 10 that have entered the traffic area A or overlapping routes (S120).

The integrated control system 200 selects a logistics robot suitable for transportation (hereinafter referred to as “the first logistics robot”) 10-1 according to the type of logistics through the integrated route setting unit 210 and determines the departure point and the destination (S130).

The integrated control system 200 transmits the ID, departure point, and destination information of the first logistics robot 10-1 to the corresponding manufacturer-specific local control system 100 (S140). At this time, the local control system 100 verifies the departure point and destination information, generates a transportation route for the first logistics robot 10-1, and transmits task assignment information including the transportation route (S150). Then, the first logistics robot 10-1 starts the logistics transportation task according to the transmitted task assignment information (S160) and determines its location information while moving, transmitting it to the local control system 100 (S170).

The integrated control system 200 collects the location information transmitted from the local control system 100 according to the logistics transportation task of the first logistics robot 10-1 through the monitoring unit 230 (S180).

In this manner, the integrated control system 200 collects the location information of the heterogeneous logistics robots 10 operating within the production plant and monitors their operational states by tracking their respective transportation routes based on the collected location information (S190).

The integrated control system 200 performs priority-based traffic control (S220) by determining, through monitoring, whether the first logistics robot 10-1 enters a traffic area A where at least one second logistics robot 10-2 is present (S200), whether an overlapping route with the second logistics robot 10-2 occurs (S210), and whether an event situation causing congestion occurs on the transportation route (S240).

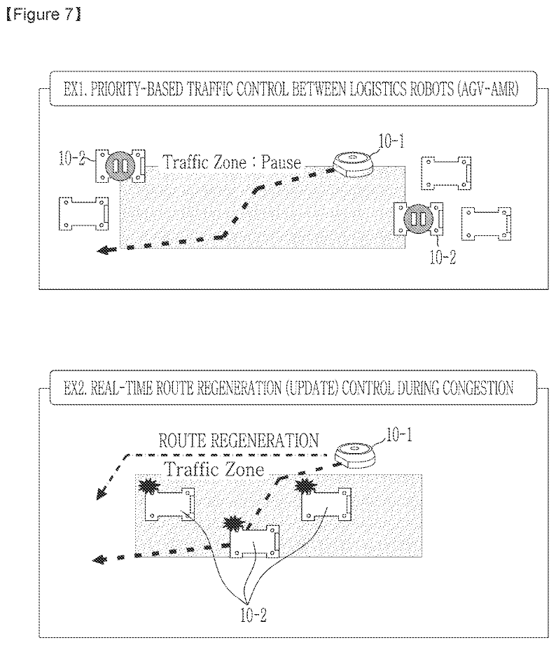

For example, FIG. 7 illustrates an example of traffic control between logistics robots in the traffic area A according to an embodiment of the present invention.

Referring to FIG. 7, as shown in EX1, if in step S200, the first logistics robot 10-1 enters the traffic area A where the second logistics robot 10-2 is present (S200: YES), the integrated control system 200 may perform traffic control by stopping or decelerating both the first logistics robot 10-1 and the second logistics robot 10-2 and then sequentially dispatching them based on the predetermined priority condition, the higher-priority first logistics robot 10-1 is dispatched first, while the lower-priority second logistics robot 10-2 is kept on standby (S220, S230). At this time, the local control system 100 corresponding to each of the first logistics robot 10-1 and the second logistics robot 10-2 may control their deceleration, stopping, or operation.

Additionally, as shown in EX2, if congestion occurs within the traffic area A due to an excessive number of logistics robots 10 or if the first logistics robot 10-1 is deprioritized, the integrated control system 200 may regenerate and transmit a real-time detour route.

Similarly, if in step S210, it is determined that an overlapping route with the second logistics robot 10-2 occurs (S210: YES), the integrated control system 200 may perform traffic control by stopping or decelerating both the first logistics robot 10-1 and the second logistics robot 10-2 and then sequentially dispatching one of them first based on the predetermined priority condition (S220).

Furthermore, the integrated control system 200 monitors whether an obstacle or congestion event occurs along the transportation route of the first logistics robot 10-1 (S240).

If the integrated control system 200 detects that an obstacle or congestion event has occurred on the transportation route of the first logistics robot 10-1 (S240: YES), it checks the monitoring status and regenerates a real-time detour route (S250). The integrated control system 200 then performs traffic control by transmitting the regenerated detour route to the first logistics robot 10-1 through the corresponding local control system 100 for route update (S260).

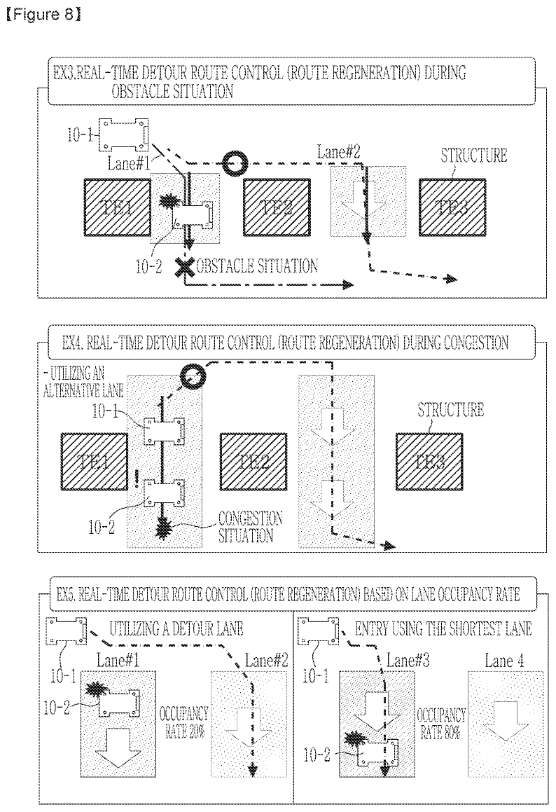

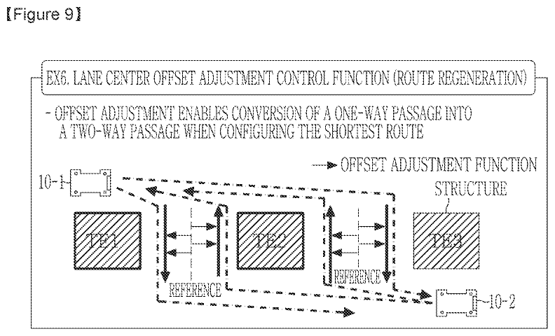

For example, FIGS. 8 and 9 illustrate examples of traffic control for logistics robots in response to a front obstacle event according to an embodiment of the present invention.

In FIGS. 8 and 9, reference numerals TE1, TE2, and TE3 indicate structures that logistics robots must avoid.

Referring to FIGS. 8 and 9, as shown in EX3, when an obstacle (e.g., a failure) caused by the second logistics robot 10-2 occurs in front, the integrated control system 200 may cancel the existing transportation route using the first lane (Lane#1) and regenerate a detour route using the second lane (Lane#2), which is then transmitted to the first logistics robot 10-1.

Additionally, as shown in EX4, when a congestion situation occurs ahead, the integrated control system 200 may regenerate a detour route using a different lane and transmit it to the first logistics robot 10-1.

Furthermore, as shown in EX5, the integrated control system 200 may compare the occupancy rates of the first lane (Lane#1) in the existing transportation route and the second lane (Lane#2) in the detour route and reset the route to utilize the second lane (Lane#2) with a lower occupancy rate. Alternatively, even if the occupancy rate is higher, the system may reset the route to use the lane with the shortest distance.

Additionally, as shown in EX6, the integrated control system 200 may implement a bidirectional passage by adjusting the offset distance on both the left and right sides of a single lane set at the center of a passage between structures. In this case, AGVs 11 passing through the passage section may recognize the adjusted offset based on the center of the lane and move along either the left or right side of the passage. As a result, limited space may be efficiently utilized to facilitate the smooth movement of AGVs 11.

Accordingly, an embodiment of the present invention enables traffic control between heterogeneous logistics robots from different manufacturers that cannot communicate with each other, without requiring additional configurations, by integrating their operation through an integrated control system implemented in a production plant.

Additionally, by monitoring the operational states of heterogeneous logistics robots through manufacturer-specific local control systems and identifying logistics robots entering fixed traffic areas, such as intersections, or overlapping routes, priority-based traffic control may be performed, ensuring a smooth supply of logistics.

Furthermore, by detecting obstacle events or congestion situations on transportation routes of logistics robots in real time and controlling them to quickly move along detour routes to avoid such situations, the turnover rate of logistics robots may be maximized, reducing additional deployment costs and achieving maximum operational efficiency with a minimal number of logistics robots.

The embodiments of the present invention are not limited to being implemented solely through the devices and/or methods described above, and the present invention may also be implemented through a program designed to realize functions corresponding to the configurations of the embodiments, a recording medium storing such a program, or other means. Such implementations can be readily realized by those skilled in the art based on the descriptions of the foregoing embodiments.

Although the embodiments of the present invention have been described in detail above, the scope of the present invention is not limited thereto, and various modifications and improvements made by those skilled in the art using the fundamental concepts of the present invention, as defined in the following claims, also fall within the scope of the present invention.

1. A heterogeneous logistics robot integrated operation system, comprising:
a first logistics robot configured to transport logistics in a production plant and a second logistics robot configured to be a different model from the first logistics robot;
a first local control system configured to control an operational state of the first logistics robot and a second local control system configured to control an operational state of the second logistics robot;
an integrated control system configured to collect location information of the first logistics robot and the second logistics robot and monitor whether the first logistics robot and the second logistics robot are simultaneously located within a preset traffic area based on the location information;
wherein, when the first logistics robot and the second logistics robot are simultaneously located within the traffic area, at least one of the integrated control system and the local control system is configured to perform traffic control by stopping or decelerating the logistics robots and then sequentially operating according to a predetermined priority condition.

2. The heterogeneous logistics robot integrated operation system of claim 1, wherein the integrated control system is configured to perform traffic control by tracking transportation routes of the logistics robots, identifying and stopping a plurality of logistics robots present in an overlapping route, and sequentially dispatching the plurality of logistics robots according to a predetermined priority condition.

3. The heterogeneous logistics robot integrated operation system of claim 1, wherein the local control system is configured to identify location information of heterogeneous logistics robots including an Automated Guided Vehicle (AGV) and an Autonomous Mobile Robot (AMR) and transmit the location information to the integrated control system.

4. The heterogeneous logistics robot integrated operation system of claim 1, wherein the location information includes a logistics robot ID, a current coordinate in a factory map (MAP) coordinate system, a movement direction and a speed.

5. The heterogeneous logistics robot integrated operation system of claim 1, wherein the integrated control system comprises:
a task management unit configured to select at least one logistics robot required for transportation based on logistics sequence information according to the type of logistics and to determine a departure point and a destination;
a traffic area setting unit configured to set a traffic area for priority-based traffic control at intersections where transportation routes of the logistics robots overlap;
a monitoring unit configured to collect location information of the logistics robots through the local control system and monitor traffic occurrence conditions;
a database (DB) configured to store at least one program and data for the integrated operation of the heterogeneous logistics robots; and
a control unit configured to check current location information of logistics robots that have entered the traffic area and control the logistics robots to decelerate or temporarily stop according to the section corresponding to the traffic area through the local control system.

6. The heterogeneous logistics robot integrated operation system of claim 5, wherein the traffic area setting unit is configured to provide a factory design drawing (CAD) through a traffic control setting screen and set a traffic area in a section where traffic occurs by utilizing various shapes.

7. The heterogeneous logistics robot integrated operation system of claim 1, wherein the traffic area is set in a section designated (Draw) by a user or is automatically set by detecting traffic coordinates where a plurality of routes overlap on the design drawing.

8. The heterogeneous logistics robot integrated operation system of claim 7, wherein the traffic area includes an alert section, a warning section, and a standby section, each having a different shape size based on the level of risk centered on the traffic coordinates, and is configured to perform deceleration or stop control according to the section corresponding to the location information of the logistics robot.

9. The heterogeneous logistics robot integrated operation system of claim 5, wherein the traffic area setting unit is configured to set a priority condition for the traffic control through a traffic control setting screen, the priority condition being used to sequentially dispatch logistics robots that have stopped after entering the traffic area or an overlapping route.

10. The heterogeneous logistics robot integrated operation system of claim 1, wherein the priority condition includes at least one of: an order in which logistics robots have lower remaining battery levels, an order in which logistics robots have shorter remaining distances to the destination, an order in which logistics robots have higher process priority, an order in which logistics robots have longer remaining distances to the destination, an order in which logistics robots have higher supply priority, an order in which logistics robots have higher retrieval priority, an order in which priority is higher between different models (AGV/AMR), and an order in which priority is higher between process cells (Cell).

11. The heterogeneous logistics robot integrated operation system of claim 10, wherein the priority condition has a relative priority weight value applied to each item, and the weight value is variably adjusted according to the work schedule in the production plant and the operational status of the logistics robots.

12. The heterogeneous logistics robot integrated operation system of claim 5, wherein the control unit is configured to track the location of the logistics robot through the monitoring unit, detect entry into the traffic area, and transmit a deceleration or stop command through the local control system corresponding to the model of the logistics robot.

13. The heterogeneous logistics robot integrated operation system of claim 12, wherein the control unit is configured to determine the priority of a plurality of logistics robots present in the traffic area based on the priority condition and control the sequential dispatch or movement of the plurality of logistics robots.

14. The heterogeneous logistics robot integrated operation system of claim 5, wherein the control unit is configured to generate a virtual robot area at a predetermined distance from the perimeter of the logistics robot through the monitoring unit to ensure a safety distance and control the logistics robot to stop when the virtual robot areas overlap with each other.

15. The heterogeneous logistics robot integrated operation system of claim 5, wherein the control unit is configured to regenerate and transmit a detour route through the integrated route setting unit based on monitoring when at least one of an obstacle situation in front of the logistics robot, a congestion situation, or lane-specific congestion is detected.

16. A method for integrated operation of heterogeneous logistics robots, wherein an integrated control system operates heterogeneous logistics robots of different models, the method comprising:
setting a traffic area in a section where transportation routes overlap in a production plant and setting a priority condition for traffic control of logistics robots that have entered the traffic area;
determining a departure point and a destination of a first logistics robot for logistics transportation and generating task assignment information including a transportation route through a first local control system to operate the first logistics robot;
collecting location information of the first logistics robot from the first local control system and monitoring an operational state of the first logistics robot; and
performing traffic control by stopping or decelerating the first logistics robot when monitoring detects that the first logistics robot has entered the traffic area where at least one second logistics robot is present or when an overlapping route with the second logistics robot occurs, and then sequentially operating according to a predetermined priority condition.

17. The method for integrated operation of heterogeneous logistics robots of claim 16, wherein the performing of the traffic control comprises:
determining a higher-priority logistics robot and a lower-priority logistics robot based on a priority condition that includes at least one of an order in which logistics robots have lower remaining battery levels, an order in which logistics robots have shorter remaining distances to the destination, an order in which logistics robots have higher process priority, an order in which logistics robots have longer remaining distances to the destination, an order in which logistics robots have higher supply priority, an order in which logistics robots have higher retrieval priority, an order in which priority is higher between different models (AGV/AMR), and an order in which priority is higher between process cells (Cell); and
dispatching the higher-priority logistics robot first and keeping the lower-priority logistics robot on standby.

18. The method for integrated operation of heterogeneous logistics robots of claim 16, wherein the performing of the traffic control comprises:
decelerating and stopping the first logistics robot and the second logistics robot through the first local control system and the second local control system when an overlapping route with the second logistics robot occurs; and
dispatching either the first logistics robot or the second logistics robot first based on the priority condition while keeping the lower-priority logistics robot on standby.

19. The method for integrated operation of heterogeneous logistics robots of claim 16, wherein the performing of the traffic control further comprises:
detecting, through monitoring, an occurrence of an obstacle or congestion event on the transportation route of the first logistics robot; and
regenerating a detour route through a task management unit or the first local control system and transmitting the detour route to the first logistics robot.

20. The method for integrated operation of heterogeneous logistics robots of claim 19, wherein the regenerating of the detour route comprises at least one of:
canceling an existing transportation route that uses a first lane (Lane#1) where the event has occurred and regenerating a detour route using a second lane (Lane#2), and
comparing the occupancy rates of the first lane (Lane#1) in the existing transportation route and the second lane (Lane#2) in the detour route and resetting the route to utilize the second lane (Lane#2) with a lower occupancy rate.
